(19) United States
(12) Patent Application Publication
(10) Pub. No.: US 2023/0088102 A1
(43) Pub. Date: Mar. 23, 2023

(54) SYSTEM FOR REAL-TIME ASSESSMENT OF ELECTRONIC DIGITAL CERTIFICATES

(71) Applicant: BANK OF AMERICA CORPORATION, Charlotte, NC (US)

(72) Inventors: Manu Jacob Kurian, Dallas, TX (US); Michael Robert Young, Davidson, NC (US)

(73) Assignee: BANK OF AMERICA CORPORATION, Charlotte, NC (US)

(21) Appl. No.: 17/480,744

(22) Filed: Sep. 21, 2021

(51) Int. Cl. G06Q 40/08; G06Q 10/10; H04L 9/32; H04L 9/08

(52) U.S. Cl. CPC G06Q 40/08; G06Q 10/10; H04L 9/3263; H04L 9/0872

(57) ABSTRACT

Systems, computer program products, and methods are described herein for the real-time assessment of electronic digital certificates. The present invention is configured to generate an electronic digital certificate associated with a resource, record the electronic digital certificate on a distributed ledger, generate a metadata layer for the electronic digital certificate that has values describing specific attributes of the resource, determine, based on the values describing the specific attributes, and record the valuation in the metadata layer of the electronic digital certificate, an estimated value of the electronic digital certificate. In some embodiments, the predetermined values describing specific attributes of the resource are used to assign an insurance policy to the resource. Additionally, or alternatively, the predetermined values describing specific attributes of the resource may be compared to real-time values describing specific attributes of the resource to update the estimated value or to alter the insurance policy.

### FIELD OF THE INVENTION

The present invention embraces an electronic system for the real-time assessment of electronic digital certificates.

### BACKGROUND

Electronic digital certificates may be used to tokenize a resource or artifact. Currently, there is no way of appraising the value of the electronic digital certificate in real-time. As such, there exists a need to provide real-time assessments of electronic digital certificates using predetermined limits pertaining to the resources, or artifacts, value.

### SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. This summary presents some concepts of one or more embodiments of the present invention in a simplified form as a prelude to the more detailed description that is presented later.

In one aspect, a system for real-time assessment of electronic digital certificates is presented. The system may include at least one non-transitory storage device and at least one processing device coupled to the at least one non-transitory storage device, where the at least one processing device may be configured to: generate an electronic digital certificate associated with a resource, where the resource has specific attributes; record the electronic digital certificate on a distributed ledger; generate a metadata layer for the electronic digital certificate, where the metadata layer comprises predetermined values describing specific attributes of the resource; determine, based on the predetermined values describing the specific attributes of the resource, an estimated value for the electronic digital certificate; record the estimated value in the metadata layer of the electronic digital certificate. In some embodiments, the specific attributes of the resource are at least one of a measurement of size, a measurement of weight, a measurement of distance, a measurement of purity, a presence or absence of an identified part, a presence or absence of an identified property, a geographical location, or a chain of custody.

In some embodiments, the at least one processing device may be configured to receive, from a user, real-time values describing the specific attributes of the resource; compare the real-time values describing the specific attributes of the resource to the predetermined values describing the specific attributes of the resource; and if the real-time values describing the specific attributes of the resource do not equal the predetermined values describing the specific attributes of the resource, calculate an updated estimated values of the electronic digital certificate. In some embodiments, the updated estimated value of the electronic digital certificate is calculated by subtracting a predetermined amount from the estimated value of the electronic digital certificate.

Additionally, or alternatively, the at least one processing device may be configured to assign an insurance policy for the resource based on the predetermined values describing the specific attributes of the resource. In some embodiments, the at least one processing device is further configured to receive, from a user, real-time values describing the specific attributes of the resource; compare the real-time values describing the specific attributes of the resource to the predetermined values describing specific attributes of the resource; and if the real-time values describing the specific attributes of the resource are not equal to the predetermined values describing specific attributes of the resource, revoke the insurance policy. Additionally, or alternatively, if the real-time values describing the specific attributes of the resource are not equal to the predetermined values describing specific attributes of the resource, the at least one processing device may be configured to alter the insurance policy.

In another aspect, a computer program product for real-time assessment of electronic digital certificates, is presented. The computer program product may include a non-transitory computer-readable medium including code causing a first apparatus to: generate an electronic digital certificate associated with a resource, where the resource has specific attributes; record the electronic digital certificate on a distributed ledger; generate a metadata layer for the electronic digital certificate, where the metadata layer comprises predetermined values describing specific attributes of the resource; determine, based on the predetermined values describing the specific attributes of the resource, an estimated value for the electronic digital certificate; record the estimated value in the metadata layer of the electronic digital certificate. In some embodiments, the specific attributes of the resource are at least one of a measurement of size, a measurement of weight, a measurement of distance, a measurement of purity, a presence or absence of an identified part, a presence or absence of an identified property, a geographical location, or a chain of custody.

In some embodiments, the non-transitory computer-readable medium may include code causing the first apparatus to receive, from a user, real-time values describing the specific attributes of the resource; compare the real-time values describing the specific attributes of the resource to the predetermined values describing the specific attributes of the resource; and if the real-time values describing the specific attributes of the resource do not equal the predetermined values describing the specific attributes of the resource, calculate an updated estimated values of the electronic digital certificate. In some embodiments, the updated estimated value of the electronic digital certificate is calculated by subtracting a predetermined amount from the estimated value of the electronic digital certificate.

Additionally, or alternatively, the non-transitory computer-readable medium may include code causing the first apparatus to assign an insurance policy for the resource based on the predetermined values describing the specific attributes of the resource. In some embodiments, the non-transitory computer-readable medium may include code causing the first apparatus to receive, from a user, real-time values describing the specific attributes of the resource; compare the real-time values describing the specific attributes of the resource to the predetermined values describing specific attributes of the resource; and if the real-time values describing the specific attributes of the resource are not equal to the predetermined values describing specific attributes of the resource, revoke the insurance policy. Additionally, or alternatively, if the real-time values describing the specific attributes of the resource are not equal to the predetermined values describing specific attributes of the resource, the non-transitory computer-readable medium may include code causing the first apparatus to alter the insurance policy.

In yet another aspect, a method for real-time assessment of electronic digital certificates is provided. The method may include: generating an electronic digital certificate associated with a resource, where the resource has specific attributes; recording the electronic digital certificate on a distributed ledger; generating a metadata layer for the electronic digital certificate, where the metadata layer comprises predetermined values describing specific attributes of the resource; determining, based on the predetermined values describing the specific attributes of the resource, an estimated value for the electronic digital certificate; recording the estimated value in the metadata layer of the electronic digital certificate. In some embodiments, the specific attributes of the resource are at least one of a measurement of size, a measurement of weight, a measurement of distance, a measurement of purity, a presence or absence of an identified part, a presence or absence of an identified property, a geographical location, or a chain of custody.

In some embodiments, the method further includes receiving, from a user, real-time values describing the specific attributes of the resource; comparing the real-time values describing the specific attributes of the resource to the predetermined values describing the specific attributes of the resource; and if the real-time values describing the specific attributes of the resource do not equal the predetermined values describing the specific attributes of the resource, calculating an updated estimated values of the electronic digital certificate. In some embodiments, the updated estimated value of the electronic digital certificate is calculated by subtracting a predetermined amount from the estimated value of the electronic digital certificate.

Additionally, or alternatively, the method may include assigning an insurance policy for the resource based on the predetermined values describing the specific attributes of the resource. In some embodiments, the method may include receiving, from a user, real-time values describing the specific attributes of the resource; comparing the real-time values describing the specific attributes of the resource to the predetermined values describing specific attributes of the resource; and if the real-time values describing the specific attributes of the resource are not equal to the predetermined values describing specific attributes of the resource, revoking the insurance policy. Additionally, or alternatively, if the real-time values describing the specific attributes of the resource are not equal to the predetermined values describing specific attributes of the resource, the method may include altering the insurance policy.

The features, functions, and advantages that have been discusses may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 illustrates technical components of a system for real-time assessment of electronic digital certificates, in accordance with an embodiment of the invention;

FIG. 2 illustrates a process flow for real-time assessment of electronic digital certificates, in accordance with an embodiment of the invention;

FIG. 3 illustrates a process flow for real-time assessment of electronic digital certificates, in accordance with an embodiment of the invention; and

FIG. 4 illustrates a process flow for real-time assessment of electronic digital certificates, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As noted, the system provides a real-time assessment of electronic digital certificates. The electronic digital certificate may contain predetermined limits pertaining to the value of the resource tokenized within the electronic digital certificate. This information may be used to accurately estimate the value of the electronic digital certificate at any point in time. The system may determine the value of the resource at an initial time using recorded information describing the resource at the initial time, then at a future data the system may revalue the resource by comparing the information describing the resource at the future date. The system may record predetermined values for the information describing the resource, if the recorded information at a point in time does not meet the requirements of the predetermined values, the resource may lose its value by a predetermined amount.

Further, the system may assign an insurance policy for the resource based on the predetermined values for the information describing the resource. If the requirement of these predetermined values is not met, the resource may not be insurable anymore, or the insurance policy may change.

As used herein, an “entity” may be any institution employing information technology resources and particularly technology infrastructure configured for processing large amounts of data. Typically, the data may be related to products, services, and/or the like offered and/or provided by the entity, customers of the entity, other aspect of the operations of the entity, people who work for the entity, and/or the like. As such, the entity may be an institution, group, association, financial institution, establishment, company, union, authority, merchant, service provider, and/or the like employing information technology resources for processing large amounts of data. In some embodiments, the entity may be an institution, group, association, financial institution, establishment, company, union, authority, merchant, service provider, and/or the like hosting, sponsoring, coordinating, creating, and/or the like events, recognitions, achievements, and/or the like.

As used herein, a “user” may be an individual associated with an entity. As such, in some embodiments, the user may be an individual having past relationships, current relationships or potential future relationships with an entity. In some embodiments, a “user” may be an employee (e.g., an associate, a project manager, a manager, an administrator, an internal operations analyst, and/or the like) of the entity and/or enterprises affiliated with the entity, capable of operating systems described herein. In some embodiments, a “user” may be any individual, another entity, and/or a system who has a relationship with the entity, such as a customer, a prospective customer, and/or the like. In some embodiments, a user may be a system performing one or more tasks described herein. In some embodiments, a user may be a verified authority as described herein.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “electronic digital certificate” may refer to a digital unit of data used as a unique digital identifier for a resource. An electronic digital certificate may be stored on a distributed ledger that certifies ownership and authenticity of the resource. For purposes of this invention, a distributed ledger (e.g., blockchain) may be a database that is consensually shared and synchronized across multiple sites, institutions, or geographies, accessible by multiple people. A distributed ledger may be associated with independent computers (referred to as nodes) that record, share and synchronize transactions in their respective electronic ledgers (instead of keeping data centralized as in a traditional ledger). As such, electronic digital certificates cannot be copied, substituted, or subdivided. In specific embodiments, the electronic digital certificate may include at least relationship layer, a token layer, a metadata layer(s), and a licensing layer. The relationship layer may include a map of various users that are associated with the electronic digital certificate and their relationship to one another. For example, if the electronic digital certificate is purchased by buyer B1 from a seller S1, the relationship between B1 and S1 as a buyer-seller is recorded in the relationship layer. In another example, if the electronic digital certificate is owned by O1 and the resource itself is stored in a storage facility by storage provider SP1, then the relationship between 01 and SP1 as owner-file storage provider is recorded in the relationship layer. The token layer may include a smart contract that points to a series of metadata associated with the resource, and provides information about supply, authenticity, lineage, and provenance of the resource. The metadata layer(s) may include resource descriptors that provides information about the resource itself (e.g., resource information). These resource descriptors may be stored in the same metadata layer or grouped into multiple metadata layers. The licensing layer may include any restrictions and licensing rules associated with purchase, sale, and any other types of transfer of the resource from one person to another. Those skilled in the art will appreciate that various additional layers and combinations of layers can be configured as needed without departing from the scope and spirit of the invention.

As used herein, a “user interface” may be any device or software that allows a user to input information, such as commands and/or data, into a device, and/or that allows the device to output information to the user. For example, a user interface may include an application programmer interface (API), a graphical user interface (GUI), and/or an interface to input computer-executable instructions that direct a processing device to carry out functions. The user interface may employ input and/or output devices to input data received from a user and/or output data to a user. Input devices and/or output devices may include a display, API, mouse, keyboard, button, touchpad, touch screen, microphone, speaker, LED, light, joystick, switch, buzzer, bell, and/or other devices for communicating with one or more users.

As used herein, a “resource” may generally refer to objects, artifacts, products, devices, goods, commodities, services, offers, discounts, currency, cash, cash equivalents, rewards, reward points, benefit rewards, bonus miles, cash back, credits, and/or the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, and/or the like.

As used herein, a “source retainer” may generally refer to an account, a system, and/or the like associated with a user and/or a type of resources, such as software, a checking account, a deposit account, a savings account, a credit account, a rewards account, a rewards points account, a benefit rewards account, a bonus miles account, a cash back account, and/or the like, which may be managed and/or maintained by an entity, such as a financial institution, an electronic resource transfer institution (e.g., a credit card company, a debit card company, a prepaid card company, and/or the like), a credit union, and/or the like.

As used herein, a “distribution” and/or an “allocation” may refer to any transaction, activities, and/or communication between one or more entities, between a user and one or more entities, and/or the like. A resource distribution and/or an allocation of resources may refer to any distribution of resources such as, but not limited to, a payment, processing of funds, purchase of goods or services, a return of goods or services, a payment transaction, a credit transaction, other interactions involving a user's resource or account, and/or the like. In the context of an entity such as a financial institution, a resource distribution and/or an allocation of resources may refer to one or more of a sale of goods and/or services, initiating an automated teller machine (ATM) or online financial session, an account balance inquiry, a rewards transfer, an account money transfer or withdrawal, opening a financial application on a user's computer or mobile device, a user accessing their e-wallet, any other interaction involving the user and/or the user's device that invokes and/or is detectable by the financial institution, and/or the like. In some embodiments, the user may authorize a resource distribution and/or an allocation of resources using a resource distribution instrument (e.g., credit cards, debit cards, checks, digital wallets, currency, loyalty points, and/or the like) and/or resource distribution credentials (e.g., account numbers, resource distribution instrument identifiers, and/or the like). A resource distribution and/or an allocation of resources may include one or more of the following: renting, selling, and/or leasing goods and/or services (e.g., groceries, stamps, tickets, DVDs, vending machine items, and/or the like); making payments to creditors (e.g., paying monthly bills; paying federal, state, and/or local taxes; and/or the like); sending remittances; loading money onto stored value cards (SVCs) and/or prepaid cards; donating to charities; and/or the like. Unless specifically limited by the context, a “resource distribution,” an “allocation of resources,” a “resource transfer,” a “transaction,” a “transaction event,” and/or a “point of transaction event” may refer to any activity between a user, a merchant, an entity, and/or the like. In some embodiments, a resource distribution and/or an allocation of resources may refer to financial transactions involving direct or indirect movement of funds through traditional paper transaction processing systems (e.g., paper check processing) or through electronic transaction processing systems. In this regard, resource distributions and/or allocations of resources may refer to the user initiating a purchase for a product, service, or the like from a merchant. Typical financial resource distribution and/or financial allocations of resources include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points, and/or the like. When describing that resource transfers or transactions are evaluated, such descriptions may mean that the transaction has already occurred, is in the process of occurring or being processed, or has yet to be processed/posted by one or more financial institutions.

As used herein, “resource distribution instrument” may refer to an electronic payment vehicle, such as an electronic credit, debit card, and/or the like, associated with a source retainer (e.g., a checking account, a deposit account, a savings account, a credit account, and/or the like). In some embodiments, the resource distribution instrument may not be a “card” and may instead be account identifying information stored electronically in a user device, such as payment credentials and/or tokens and/or aliases associated with a digital wallet, account identifiers stored by a mobile application, and/or the like.

In some embodiments, the term “module” with respect to an apparatus may refer to a hardware component of the apparatus, a software component of the apparatus, and/or a component of the apparatus that includes both hardware and software. In some embodiments, the term “chip” may refer to an integrated circuit, a microprocessor, a system-on-a-chip, a microcontroller, and/or the like that may either be integrated into the external apparatus, may be inserted and/or removed from the external apparatus by a user, and/or the like.

As used herein, an “engine” may refer to core elements of a computer program, part of a computer program that serves as a foundation for a larger piece of software and drives the functionality of the software, and/or the like. An engine may be self-contained but may include externally controllable code that encapsulates powerful logic designed to perform or execute a specific type of function. In one aspect, an engine may be underlying source code that establishes file hierarchy, input and/or output methods, how a part of a computer program interacts and/or communicates with other software and/or hardware, and/or the like. The components of an engine may vary based on the needs of the computer program as part of the larger piece of software. In some embodiments, an engine may be configured to retrieve resources created in other computer programs, which may then be ported into the engine for use during specific operational aspects of the engine. An engine may be configurable to be implemented within any general-purpose computing system. In doing so, the engine may be configured to execute source code embedded therein to control specific features of the general-purpose computing system to execute specific computing operations, thereby transforming the general-purpose system into a specific purpose computing system.

As used herein, a “component” of an application may include a software package, a service, a resource, a module, and/or the like that includes a set of related functions and/or data. In some embodiments, a component may provide a source capability (e.g., a function, a business function, and/or the like) to an application including the component. In some embodiments, components of an application may communicate with each other via interfaces and may provide information to each other indicative of the services and/or functions that other components may utilize and/or how other components may utilize the services and/or functions. Additionally, or alternatively, components of an application may be substitutable such that a component may replace another component. In some embodiments, components may include objects, collections of objects, and/or the like.

As used herein, “authentication credentials” may be any information that may be used to identify a user. For example, a system may prompt a user to enter authentication information such as a username, a password, a token, a personal identification number (PIN), a passcode, biometric information (e.g., voice authentication, a fingerprint, and/or a retina scan), an answer to a security question, a unique intrinsic user activity, such as making a predefined motion with a user device, and/or the like. The authentication information may be used to authenticate the identity of the user (e.g., determine that the authentication information is associated with an account) and/or determine that the user has authority to access an account or system. In some embodiments, the system may be owned and/or operated by an entity. In such embodiments, the entity may employ additional computer systems, such as authentication servers, to validate and certify resources inputted by a plurality of users within the system. The system may further use authentication servers to certify the identity of users of the system, such that other users may verify the identity of the certified users. In some embodiments, the entity may certify the identity of the users. Furthermore, authentication information and/or permission may be assigned to and/or required from a user, application, computing node, computing cluster, and/or the like to access stored data within at least a portion of the system.

As used herein, an “interaction” may refer to any communication between one or more users, one or more entities or institutions, and/or one or more devices, nodes, clusters, and/or systems within the system environment described herein. For example, an interaction may refer to a transfer of data between devices, an accessing of stored data by one or more nodes of a computing cluster, a transmission of a requested task, and/or the like. In some embodiments, an interaction may refer to an entity, a user, a system, and/or a device providing an advertisement, information, data, a user interface, and/or the like to another entity, another user, another system, and/or another device.

As used herein, identifiers such as “first,” “second,” “third,” and/or the like do not indicate a temporal relationship, unless explicitly stated. Such identifiers may modify instances of similar things and may be used to differentiate between each of the instances.

As used herein, an “estimated value” is a valuation of a resource. In some embodiments, the estimated value may be determined by consulting with an authorized appraiser. Additionally, or alternatively, the estimated value may be determined by comparison with other like resources.

As used herein, an “insurance policy” may refer to a contract between two parties wherein a first party receives financial protection against losses from a second party. An insurance policy may have a premium, or cost. An insurance policy may have a policy limit, or maximum amount of protection. An insurance policy may have a deductible or amount the first party must pay before the second party pays. An insurance policy may have provisions that dictate the rules that each party must abide by.

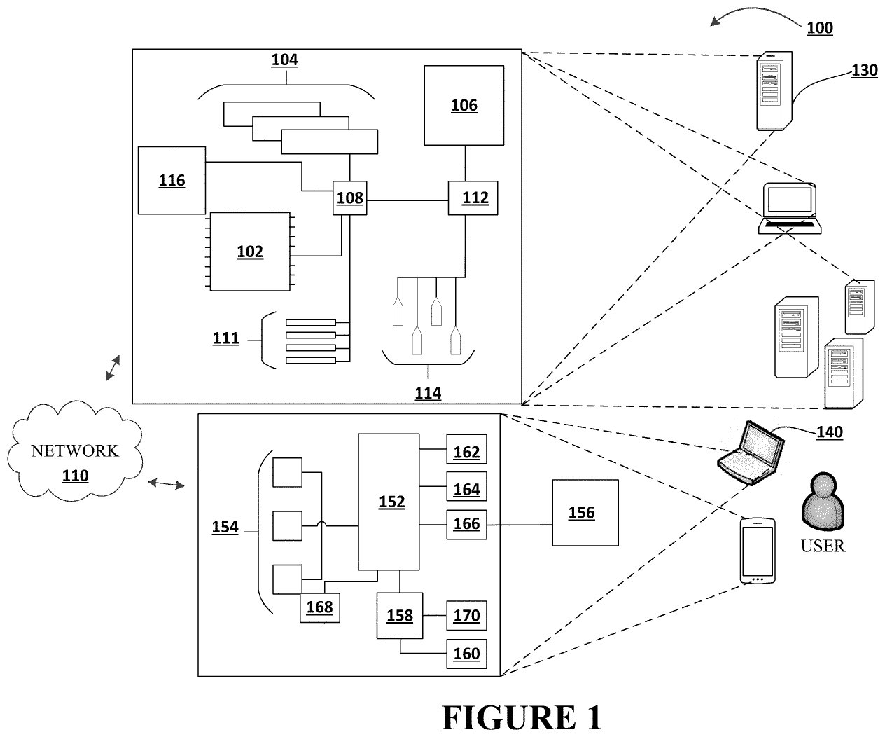

FIG. 1 presents an exemplary block diagram of a system environment 100 for generating and managing electronic digital certificates, in accordance with an embodiment of the invention. FIG. 1 provides a system environment 100 that includes specialized servers and a system communicably linked across a distributive network of nodes required to perform functions of process flows described herein in accordance with embodiments of the present invention.

As illustrated, the system environment 100 includes a network 110, a system 130, and a user input system 140. Also shown in FIG. 1 is a user of the user input system 140. The user input system 140 may be a mobile device, a non-mobile computing device, and/or the like. The user may be a person who uses the user input system 140 to access, view modify, interact with, and/or the like information, data, images, video, and/or the like. The user may be a person who uses the user input system 140 to initiate, perform, monitor, and/or the like changes and/or modifications to one or more systems, applications, services, and/or the like. The one or more systems, applications, services, and/or the like may be configured to communicate with the system 130, input information onto a user interface presented on the user input system 140, and/or the like. The applications stored on the user input system 140 and the system 130 may incorporate one or more parts of any process flow described herein.

As shown in FIG. 1, the system 130 and the user input system 140 are each operatively and selectively connected to the network 110, which may include one or more separate networks. In some embodiments, the network 110 may include a telecommunication network, local area network (LAN), a wide area network (WAN), and/or a global area network (GAN), such as the Internet. Additionally, or alternatively, the network 110 may be secure and/or unsecure and may also include wireless and/or wired and/or optical interconnection technology.

In some embodiments, the system 130 and the user input system 140 may be used to implement processes described herein, including user-side and server-side processes generating limited-transferability electronic digital certificates associated with events, in accordance with an embodiment of the present invention. The system 130 may represent various forms of digital computers, such as laptops, desktops, workstations, personal digital assistants, servers, blade servers, mainframes, and/or the like. The user input system 140 may represent various forms of mobile devices, such as personal digital assistants, cellular telephones, smartphones, smart glasses, and/or the like. The components shown here, their connections, their relationships, and/or their functions, are meant to be exemplary only, and are not meant to limit implementations of the inventions described and/or claimed in this document.

In some embodiments, the system 130 may include a processor 102, memory 104, a storage device 106, a high-speed interface 108 connecting to memory 104, high-speed expansion ports 111, and a low-speed interface 112 connecting to low-speed bus 114 and storage device 106. Each of the components 102, 104, 106, 108, 111, and 112 may be interconnected using various buses, and may be mounted on a common motherboard or in other manners as appropriate. The processor 102 may process instructions for execution within the system 130, including instructions stored in the memory 104 and/or on the storage device 106 to display graphical information for a GUI on an external input/output device, such as a display 116 coupled to a high-speed interface 108. In some embodiments, multiple processors, multiple buses, multiple memories, multiple types of memory, and/or the like may be used. Also, multiple systems, same or similar to system 130 may be connected, with each system providing portions of the necessary operations (e.g., as a server bank, a group of blade servers, a multi-processor system, and/or the like). In some embodiments, the system 130 may be managed by an entity, such as a business, a merchant, a financial institution, a card management institution, a software and/or hardware development company, a software and/or hardware testing company, and/or the like. The system 130 may be located at a facility associated with the entity and/or remotely from the facility associated with the entity.

The memory 104 may store information within the system 130. In one implementation, the memory 104 may be a volatile memory unit or units, such as volatile random-access memory (RAM) having a cache area for the temporary storage of information. In another implementation, the memory 104 may be a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like. The memory 104 may store any one or more of pieces of information and data used by the system in which it resides to implement the functions of that system. In this regard, the system may dynamically utilize the volatile memory over the non-volatile memory by storing multiple pieces of information in the volatile memory, thereby reducing the load on the system and increasing the processing speed.

The storage device 106 may be capable of providing mass storage for the system 130. In one aspect, the storage device 106 may be or contain a computer-readable medium, such as a floppy disk device, a hard disk device, an optical disk device, a tape device, a flash memory and/or other similar solid state memory device, and/or an array of devices, including devices in a storage area network or other configurations. A computer program product may be tangibly embodied in an information carrier. The computer program product may also contain instructions that, when executed, perform one or more methods, such as those described herein. The information carrier may be a non-transitory computer-readable or machine-readable storage medium, such as the memory 104, the storage device 106, and/or memory on processor 102.

In some embodiments, the system 130 may be configured to access, via the network 110, a number of other computing devices (not shown). In this regard, the system 130 may be configured to access one or more storage devices and/or one or more memory devices associated with each of the other computing devices. In this way, the system 130 may implement dynamic allocation and de-allocation of local memory resources among multiple computing devices in a parallel and/or distributed system. Given a group of computing devices and a collection of interconnected local memory devices, the fragmentation of memory resources is rendered irrelevant by configuring the system 130 to dynamically allocate memory based on availability of memory either locally, or in any of the other computing devices accessible via the network. In effect, the memory may appear to be allocated from a central pool of memory, even though the memory space may be distributed throughout the system. Such a method of dynamically allocating memory provides increased flexibility when the data size changes during the lifetime of an application and allows memory reuse for better utilization of the memory resources when the data sizes are large.

The high-speed interface 108 may manage bandwidth-intensive operations for the system 130, while the low-speed interface 112 and/or controller manages lower bandwidth-intensive operations. Such allocation of functions is exemplary only. In some embodiments, the high-speed interface 108 is coupled to memory 104, display 116 (e.g., through a graphics processor or accelerator), and to high-speed expansion ports 111, which may accept various expansion cards (not shown). In some embodiments, low-speed interface 112 and/or controller is coupled to storage device 106 and low-speed bus 114 (e.g., expansion port). The low-speed bus 114, which may include various communication ports (e.g., USB, Bluetooth, Ethernet, wireless Ethernet), may be coupled to one or more input/output devices, such as a keyboard, a pointing device, a scanner, and/or a networking device such as a switch or router (e.g., through a network adapter).

The system 130 may be implemented in a number of different forms, as shown in FIG. 1. For example, it may be implemented as a standard server or multiple times in a group of such servers. Additionally, or alternatively, the system 130 may be implemented as part of a rack server system, a personal computer, such as a laptop computer, and/or the like. Alternatively, components from system 130 may be combined with one or more other same or similar systems and the user input system 140 may be made up of multiple computing devices communicating with each other.

FIG. 1 also illustrates a user input system 140, in accordance with an embodiment of the invention. The user input system 140 may include a processor 152, memory 154, an input/output device such as a display 156, a communication interface 158, and a transceiver 160, among other components, such as one or more image sensors. The user input system 140 may also be provided with a storage device, such as a microdrive and/or the like, to provide additional storage. Each of the components 152, 154, 158, and 160, may be interconnected using various buses, and several of the components may be mounted on a common motherboard or in other manners as appropriate.

The processor 152 may be configured to execute instructions within the user input system 140, including instructions stored in the memory 154. The processor 152 may be implemented as a chipset of chips that include separate and multiple analog and/or digital processors. The processor 152 may be configured to provide, for example, for coordination of the other components of the user input system 140, such as control of user interfaces, applications run by user input system 140, and/or wireless communication by user input system 140.

The processor 152 may be configured to communicate with the user through control interface 164 and display interface 166 coupled to a display 156. The display 156 may be, for example, a Thin-Film-Transistor Liquid Crystal Display (TFT LCD) or an Organic Light Emitting Diode (OLED) display, and/or other appropriate display technology. An interface of the display 156 may include appropriate circuitry and may be configured for driving the display 156 to present graphical and other information to a user. The control interface 164 may receive commands from a user and convert them for submission to the processor 152. In addition, an external interface 168 may be provided in communication with processor 152 to enable near area communication of user input system 140 with other devices. External interface 168 may provide, for example, for wired communication in some implementations, or for wireless communication in other implementations, and multiple interfaces may also be used.

The memory 154 may store information within the user input system 140. The memory 154 may be implemented as one or more of a computer-readable medium or media, a volatile memory unit or units, or a non-volatile memory unit or units. Expansion memory may also be provided and connected to user input system 140 through an expansion interface (not shown), which may include, for example, a Single In Line Memory Module (SIMM) card interface. Such expansion memory may provide extra storage space for user input system 140 and/or may store applications and/or other information therein. In some embodiments, expansion memory may include instructions to carry out or supplement the processes described above and/or may include secure information. For example, expansion memory may be provided as a security module for user input system 140 and may be programmed with instructions that permit secure use of user input system 140. Additionally, or alternatively, secure applications may be provided via the SIMM cards, along with additional information, such as placing identifying information on the SIMM card in a secure manner. In some embodiments, the user may use applications to execute processes described with respect to the process flows described herein. For example, one or more applications may execute the process flows described herein. In some embodiments, one or more applications stored in the system 130 and/or the user input system 140 may interact with one another and may be configured to implement any one or more portions of the various user interfaces and/or process flow described herein.

The memory 154 may include, for example, flash memory and/or NVRAM memory. In some embodiments, a computer program product may be tangibly embodied in an information carrier. The computer program product may contain instructions that, when executed, perform one or more methods, such as those described herein. The information carrier may be a computer-readable or machine-readable medium, such as the memory 154, expansion memory, memory on processor 152, and/or a propagated signal that may be received, for example, over transceiver 160 and/or external interface 168.

In some embodiments, the user may use the user input system 140 to transmit and/or receive information and/or commands to and/or from the system 130. In this regard, the system 130 may be configured to establish a communication link with the user input system 140, whereby the communication link establishes a data channel (wired and/or wireless) to facilitate the transfer of data between the user input system 140 and the system 130. In doing so, the system 130 may be configured to access one or more aspects of the user input system 140, such as, a GPS device, an image capturing component (e.g., camera), a microphone, a speaker, and/or the like.

The user input system 140 may communicate with the system 130 (and one or more other devices) wirelessly through communication interface 158, which may include digital signal processing circuitry. Communication interface 158 may provide for communications under various modes or protocols, such as GSM voice calls, SMS, EMS, or MMS messaging, CDMA, TDMA, PDC, WCDMA, CDMA2000, GPRS, and/or the like. Such communication may occur, for example, through transceiver 160. Additionally, or alternatively, short-range communication may occur, such as using a Bluetooth, Wi-Fi, and/or other such transceiver (not shown). Additionally, or alternatively, a Global Positioning System (GPS) receiver module 170 may provide additional navigation-related and/or location-related wireless data to user input system 140, which may be used as appropriate by applications running thereon, and in some embodiments, one or more applications operating on the system 130.

The user input system 140 may also communicate audibly using audio codec 162, which may receive spoken information from a user and convert it to usable digital information. Audio codec 162 may likewise generate audible sound for a user, such as through a speaker (e.g., in a handset) of user input system 140. Such sound may include sound from voice telephone calls, may include recorded sound (e.g., voice messages, music files, and/or the like) and may also include sound generated by one or more applications operating on the user input system 140, and in some embodiments, one or more applications operating on the system 130.

Various implementations of the systems and techniques described here may be realized in digital electronic circuitry, integrated circuitry, specially designed ASICs (application specific integrated circuits), computer hardware, firmware, software, and/or combinations thereof. Such various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and/or at least one output device.

Computer programs (e.g., also referred to as programs, software, applications, code, and/or the like) may include machine instructions for a programmable processor, and may be implemented in a high-level procedural and/or object-oriented programming language, and/or in assembly/machine language. As used herein, the terms “machine-readable medium” and/or “computer-readable medium” may refer to any computer program product, apparatus and/or device (e.g., magnetic discs, optical disks, memory, Programmable Logic Devices (PLDs), and/or the like) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and/or techniques described herein may be implemented on a computer having a display device (e.g., a CRT (cathode ray tube), an LCD (liquid crystal display) monitor, and/or the like) for displaying information to the user, a keyboard by which the user may provide input to the computer, and/or a pointing device (e.g., a mouse or a trackball) by which the user may provide input to the computer. Other kinds of devices may be used to provide for interaction with a user as well. For example, feedback provided to the user may be any form of sensory feedback (e.g., visual feedback, auditory feedback, and/or tactile feedback). Additionally, or alternatively, input from the user may be received in any form, including acoustic, speech, and/or tactile input.

The systems and techniques described herein may be implemented in a computing system that includes a back end component (e.g., as a data server), that includes a middleware component (e.g., an application server), that includes a front end component (e.g., a client computer having a graphical user interface or a Web browser through which a user may interact with an implementation of the systems and techniques described here), and/or any combination of such back end, middleware, and/or front end components. Components of the system may be interconnected by any form or medium of digital data communication (e.g., a communication network). Examples of communication networks include a local area network (“LAN”), a wide area network (“WAN”), and/or the Internet.

In some embodiments, computing systems may include clients and servers. A client and server may generally be remote from each other and typically interact through a communication network. The relationship of client and server may arise by virtue of computer programs running on the respective computers and having a client-server relationship to each other.

The embodiment of the system environment 100 illustrated in FIG. 1 is exemplary and other embodiments may vary. As another example, in some embodiments, the system 130 includes more, less, or different components. As another example, in some embodiments, some or all of the portions of the system environment 100, the system 130, and/or the user input system 140 may be combined into a single portion. Likewise, in some embodiments, some or all of the portions of the system environment 100, the system 130, and/or the user input system 140 may be separated into two or more distinct portions.

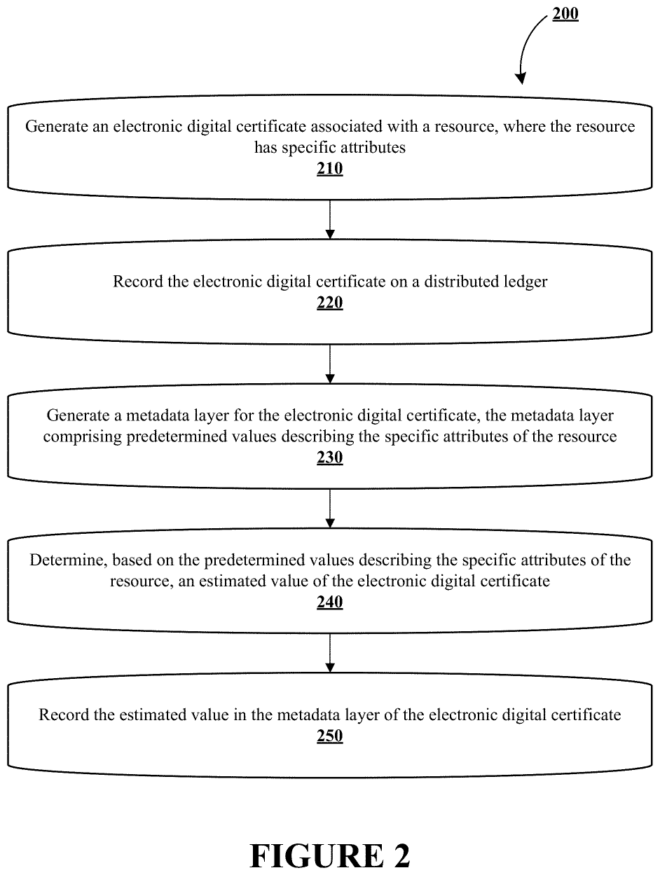

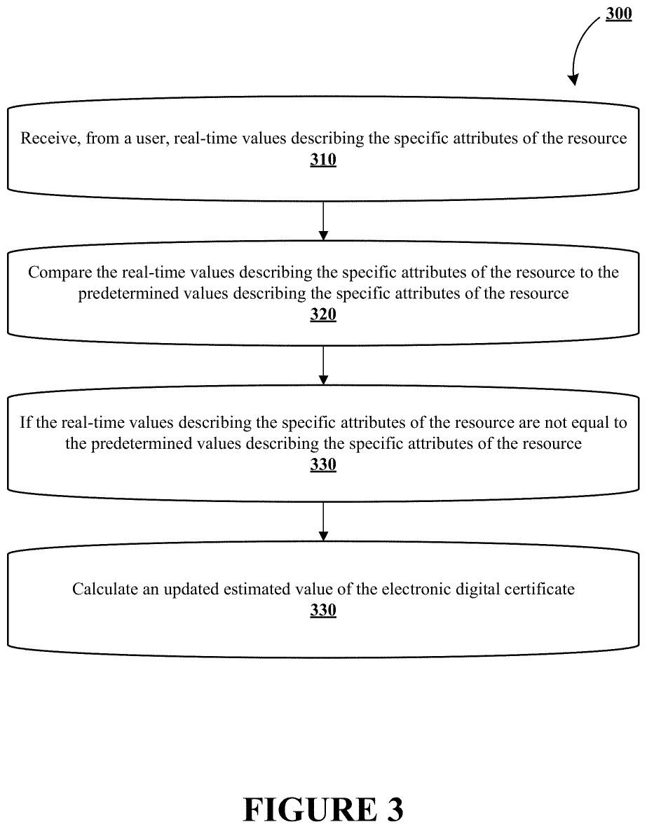

In some embodiments, the system environment may 100 include one or more user input systems and/or one or more electronic digital certificate generating systems (e.g., similar to the system 130 and/or the user input system 140) associated with an entity (e.g., a business, a merchant, a financial institution, a card management institution, an software and/or hardware development company, a software and/or hardware testing company, and/or the like). For example, a user (e.g., an employee, a customer, and/or the like) may use a user input system (e.g., similar to the user input system 140) to initiate generation of one or more electronic digital certificates associated with one or more resources, collections, groups of artifacts, and/or the like using one or more systems, applications, services, and/or the like (e.g., similar to the system 130, running a system similar to the system 130, and/or the like) and the user input system may provide information (e.g., event information, user information, and/or the like) to an electronic digital certificate generating system (e.g., similar to the system 130, running a system similar to the system 130, and/or the like). In some embodiments, the user input system and/or the electronic digital certificate generating system associated with the entity may perform one or more of the steps described herein with respect to the process flows described herein with respect to FIGS. 2, 3, and/or 4.

FIG. 2 illustrates a process flow 200 for real-time assessment of electronic digital certificates, in accordance with an embodiment of the invention. In some embodiments, the real-time electronic digital certificate assessment system and/or the like (e.g., similar to one or more of the systems described herein with respect to FIG. 1) may perform one or more of the steps of process flow 200.

As shown in block 210, the process flow 200 may include generating an electronic digital certificate associated with a resource, where the resource has specific attributes. For example, an electronic digital certificate generating system may generate an electronic digital certificate based on receiving information from a user associated with the resource (e.g., a user that owns the resource, a user that maintains the resource, and/or the like). In some embodiments, the resource may be a physical artifact such as an art piece, a vehicle, real estate, and/or the like. Additionally, or alternatively, the resource may be a digital artifact such as software, a digital image, a digital sound file, a video, and/or the like.

As shown in block 220, the process flow 200 may include recording the electronic digital certificate on a distributed ledger. In some embodiments, the electronic digital certificate may comprise a smart contract. In some embodiments, a smart contract provides the electronic digital certificate with an insurance policy. Additionally, or alternatively, the smart contract may assign a power of attorney for the electronic digital certificate. It should be understood that a smart contract is a self-executing contract with the terms of any agreement being directly written into lines of code. The code and the agreements contained therein exist across a distributed ledger or a decentralized blockchain network.

As shown in block 230, the process flow 200 may include generating a metadata layer for the electronic digital certificate. The metadata layer contains predetermined values describing the specific attributes of the resource.

As shown in block 240, the process flow 200 may include determining an estimated value for the electronic digital certificate based on the predetermined values describing the specific attributes of the resource.

As shown in block 250, the process flow 200 may include recording the estimated value in the metadata layer of the electronic digital certificate.

Process flow 200 may include additional embodiments, such as any single embodiment or any combination of embodiments described below and/or in connection with one or more other processes described elsewhere herein.

In a first embodiment, the specific attribute of the resource may be a measurement of size. For example, a measurement of square foot and/or acreage in the case where the resource is real estate property such as land, home, building, etc. In another example, the measurement of size may be a volume, or three-dimensional measurement, of the resource. In another example, the measurement of size may be a number of pieces, in the case where the resource is a collection of items. In another example, the measurement of size may be a file size in the case where the resource is a digital artifact. It should be understood that a measurement of size can be anything measuring the magnitude of the resource or a part of a resource.

In a second embodiment alone or in combination with the first embodiment, the specific attribute of the resource may be a measurement of weight or mass. In an example, where the resource is a precious material, such as gold or other metals, the specific attribute may be the weight of the material.

In a third embodiment alone or in combination with any of the first through second embodiments, the specific attribute of the resource may be a measurement of distance. In one example, the measurement of distance may be the distance between the resource and another item or location.

In a fourth embodiment alone or in combination with any of the first through third embodiments, the specific attribute may be a measurement of purity. In some examples, purity is measured in karats, as is the case for precious metals. In some examples, purity is measured as a percentage (percentage of weight, or percentage of volume).

In a fifth embodiment alone or in combination with any of the first through fourth embodiments, the specific attribute may be the presence or absence of an identified part. For example, in the case where the resource is a house, an identified part may be a garage, flood protection, or an air-conditioning unit; therefore the value would reflect the presence or absence of a garage, flood protection, or an air-conditioning unit. In another example, in the case where the resource is a physical art piece, an identified part may be a signature.

In a sixth embodiment alone or in combination with any of the first through fifth embodiments, the specific attribute of the resource may be the presence or absence of an identified property. In one example, the identified property may be optical transparency. In another example, the identified property may be a coefficient of friction. In another example, the identified property may be strength. In another example, the identified property may be conductivity. In some examples, the identified property may be a chemical property.

In a seventh embodiment alone or in combination with any of the first through sixth embodiments, the specific attribute of the resource may be a geographical location. As an example, the predetermined values and the real-time values may contain the name of a location where the resource is expected to be located. In another example, the predetermined values and the real-time values may contain a set of coordinates where the resource is expected to be located.

In an eighth embodiment alone or in combination with any one of the first through seventh embodiments, the specific attribute may be a chain of custody. As an example, the predetermined values and the real-time values may contain a list of names or entities representing the list of ownership or possession of the resource.

In a ninth embodiment alone or in combination with any one of the first through eighth embodiments, the predetermined values of the specific attributes and the real-time values of the specific attributes may be represented as a number and a unit. For example, the real-time values or predetermined values may contain a unit such as “inches, “meters,” “square feet,” “liter,” “gram,” “karat,” etc. In another example, the predetermined values of the specific attributes and the real-time values of the specific attributes may be represented by a number. For example, in the case where it is the count of a number in a collection, or in the case that it is the representation of the presence or absence of an identified part or property. In an example, where the specific attribute is the presence of an identified part, the parts presence may be denoted by a value of 1, and the parts absence denoted by a value of 0. In some examples, the presence of an identified part may be denoted by a value of more than one when there is more than one of the identified parts present. In some examples, the predetermined values of the specific attributes and the real-time values of the specific attributes may be represented by names, words, or letters. In the example where the specific attribute is a chain of custody, the value would be a list of names or entities.

In a tenth embodiment alone or in combination with any one of the first through ninth embodiments, the process flow 200 may further include the process flow 300 represented later in this discussion.

In an eleventh embodiment alone or in combination with any one of the first through tenth embodiments, the process flow 200 may further include the process flow 400 represented later in this discussion.

Although FIG. 2 shows example blocks of process flow 200, in some embodiments, process flow 200 may include additional blocks, fewer blocks, different blocks, or differently arranged blocks than those depicted in FIG. 2. Additionally, or alternatively, two or more of the blocks of process flow 200 may be performed in parallel.

FIG. 3 illustrates a process flow 300 for an additional embodiment of the present invention. In some embodiments, the real-time electronic digital certificate assessment system and/or the like (e.g., similar to one or more of the systems described herein with respect to FIG. 1) may perform one or more of the steps of process flow 300.

As shown in block 310, the process flow 300 may include receiving, from a user real-time values describing the specific attributes of the resource.

As shown in block 320, the process flow 300 may include comparing the real-time values describing the specific attributes of the resource to the predetermined values describing the specific attributes of the resource.

As shown in block 330, the process flow 300 a result of the comparison is that the real-time values describing the specific attributes of the resource are not equal to the predetermined values describing specific attributes of the resource. If, these values are not equal, as shown in block 340, the process flow 300 may include calculating an updated estimated value of the electronic digital certificate.

Process flow 300 may include additional embodiments, such as any single embodiment or any combination of embodiments described below and/or in connection with one or more other processes described elsewhere herein.

In a first embodiment, the calculation step represented in block 340 of process flow 300 may include subtracting a predetermined amount from the estimated value of the electronic digital certificate.

In a second embodiment alone or in combination with the first embodiment, the process flow 300 may alternatively include, after block 320, if the real-time values describing the specific attributes of the resource are equal to the predetermined values describing specific attributes of the resource, calculating an updated estimated value that is equivalent to the estimated value. Additionally, or alternatively, if the if the real-time values describing the specific attributes of the resource are equal to the predetermined values describing specific attributes of the resource, calculating an updated estimated value that takes into account new market trends for the resource.

In a third embodiment, alone or in combination with any one of the first through second embodiments, process flow 300 may be coupled with process flow 200 represented previously in this description.

In a fourth embodiment, alone or in combination with any one of the first through third embodiments, process flow 300 may be coupled with process flow 400 represented later in this description.

Although FIG. 3 shows example blocks of process flow 300, in some embodiments, process flow 300 may include additional blocks, fewer blocks, different blocks, or differently arranged blocks than those depicted in FIG. 3. Additionally, or alternatively, two or more of the blocks of process flow 300 may be performed in parallel.

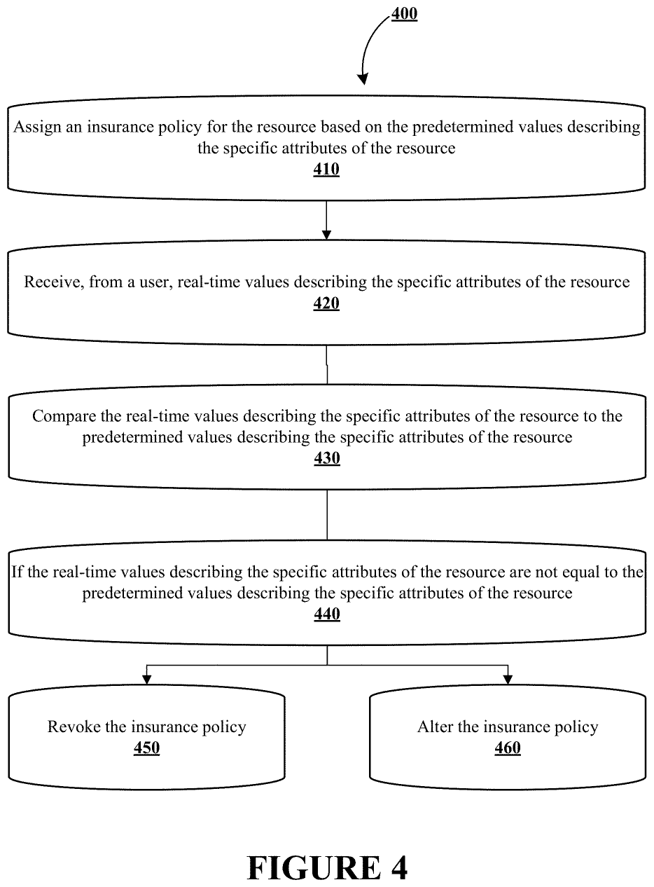

FIG. 4 illustrates a process flow 400 for an additional embodiment of the present invention. In some embodiments, the real-time electronic digital certificate assessment system and/or the like (e.g., similar to one or more of the systems described herein with respect to FIG. 1) may perform one or more of the steps of process flow 400.

As shown in block 410, the process flow 400 may include assigning an insurance policy for the resource based on the predetermined values describing the specific attributes of the resource.

As shown in block 420, the process flow 400 may include receiving, from a user, real-time values describing the specific attributes of the resource.

As shown in block 430, the process flow 400 may include comparing the real-time values describing the specific attributes of the resource to the predetermined values describing specific attributes of the resource.

As shown in block 440, a result of the comparison is that the real-time values describing the specific attributes of the resource are not equal to the predetermined values describing the specific attributes of the resource. If these values are not equal, then as shown in block 450, the process flow 400 may include revoking the insurance policy. In another embodiment, if these values are not equal, then as shown in block 460, the process flow 400 may include altering the insurance policy.

In a first embodiment, altering the insurance policy in block 460 of process flow 400 may include increasing or decreasing a rate of the insurance policy.

In a second embodiment, alone or in combination with the first embodiment, altering the insurance policy in block 460 of process flow 400 may include increasing or decreasing a deductible of the insurance policy.

In a third embodiment, alone or in combination with any one of the first or second embodiments, altering the insurance policy in block 460 of process flow 400 may include increasing or decreasing a premium of the insurance policy.

In a fourth embodiment, alone or in combination with any one of the first through third embodiments, altering the insurance policy in block 460 of process flow 400 may include increasing or decreasing a policy limit of the insurance policy.

In a fifth embodiment, alone or in combination with anyone of the first through fourth embodiments, altering the insurance policy in block 460 of process flow 400 may include deleting or adding a provision of the insurance policy.

In a sixth embodiment, alone or in combination with any one of the first through fifth embodiments, process flow 400 may alternatively include, after block 430, if the real-time values describing the specific attributes of the resource are equal to the predetermined values describing specific attributes of the resource, leaving the insurance policy the same. Additionally, or alternatively, if the real-time values describing the specific attributes of the resource are equal to the predetermined values describing specific attributes of the resource, the insurance policy may be altered based on market trends.

In a seventh embodiment, alone or in combination with any one of the first through sixth embodiments, process flow 400 may be coupled with process flow 200 represented previously in this description.

In an eighth embodiment, alone or in combination with any one of the first through seventh embodiments, process flow 400 may be coupled with process flow 300 represented previously in this description.

Process flow 400 may include additional embodiments, such as any single embodiment or any combination of embodiments described below and/or in connection with one or more other processes described elsewhere herein.

Although FIG. 4 shows example blocks of process flow 400, in some embodiments, process flow 400 may include additional blocks, fewer blocks, different blocks, or differently arranged blocks than those depicted in FIG. 4. Additionally, or alternatively, two or more of the blocks of process flow 400 may be performed in parallel.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g. a memory) that may direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments may be configured without departing from the scope and spirit of the invention. Therefore, it is to be understood that, within the scope of the appended claims, the invention may be practiced other than as specifically described herein.

What is claimed is:

1. A system for real-time assessment of electronic digital certificates, the system comprising
at least one non-transitory storage device, and
at least one processing device coupled to the at least one non-transitory storage device, wherein the at least one processing device is configured to:
generate an electronic digital certificate associated with a resource, wherein the resource has specific attributes;
record the electronic digital certificate on a distributed ledger;
generate a metadata layer for the electronic digital certificate, wherein the metadata layer comprises predetermined values describing the specific attributes of the resource;
determine, based on the predetermined values describing the specific attributes of the resource, an estimated value of the electronic digital certificate; and
record the estimated value in the metadata layer of the electronic digital certificate.

2. The system according to claim 1, wherein the specific attributes of the resource comprise at least one of a measurement of size, a measurement of weight, a measurement of distance, a measurement of purity, a presence or absence of an identified part, a presence or an absence of an identified property, a geographical location, or a chain of custody.

3. The system according to claim 1, wherein the at least one processing device is further configured to:
receive, from a user, real-time values describing the specific attributes of the resource;
compare the real-time values describing the specific attributes of the resource to the predetermined values describing the specific attributes of the resource; and
if the real-time values describing the specific attributes of the resource are not equal to the predetermined values describing the specific attributes of the resource, calculate an updated estimated value of the electronic digital certificate.

4. The system according to claim 3, wherein the updated estimated value of the electronic digital certificate is calculated by subtracting a predetermined amount from the estimated value of the electronic digital certificate.

5. The system according to claim 1, wherein the at least one processing device is further configured to assign an insurance policy for the resource based on the predetermined values describing the specific attributes of the resource.

6. The system according to claim 5, wherein the at least one processing device is further configured to:
receive, from a user, real-time values describing the specific attributes of the resource;
compare the real-time values describing the specific attributes of the resource to the predetermined values describing the specific attributes of the resource; and
if the real-time values describing the specific attributes of the resource are not equal to the predetermined values for the specific attributes of the resource, revoke the insurance policy for the resource.

7. The system according to claim 5, wherein the at least one processing device is further configured to:
receive, from a user, real-time values describing the specific attributes of the resource;
compare the real-time values describing the specific attributes of the resource to the predetermined values describing the specific attributes of the resource; and
if the real-time values describing the specific attributes of the resource are not equal to the predetermined values for the specific attributes of the resource, alter the insurance policy for the resource.

8. A computer program product for real-time assessment of electronic digital certificates, the computer program product comprising a non-transitory computer-readable medium comprising code causing a first apparatus to:
generate an electronic digital certificate associated with a resource, wherein the resource has specific attributes;
record the electronic digital certificate on a distributed ledger;
generate a metadata layer for the electronic digital certificate, wherein the metadata layer comprises predetermined values describing the specific attributes of the resource;
determine, based on the predetermined values describing the specific attributes of the resource, an estimated value of the electronic digital certificate; and
record the estimated value in the metadata layer of the electronic digital certificate.

9. The computer program product according to claim 8, wherein the specific attributes of the resource comprise at least one of a measurement of size, a measurement of weight, a measurement of distance, a measurement of purity, a presence or absence of an identified part, a presence or an absence of an identified property, a geographical location, or a chain of custody.

10. The computer program product according to claim 8, wherein the non-transitory computer-readable medium comprises code causing the first apparatus to:
receive, from a user, real-time values describing the specific attributes of the resource;
compare the real-time values describing the specific attributes of the resource to the predetermined values describing the specific attributes of the resource; and
if the real-time values describing the specific attributes of the resource are not equal to the predetermined values describing the specific attributes of the resource, calculate an updated estimated value of the electronic digital certificate.

11. The computer program product according to claim 10, wherein the updated estimated value of the electronic digital certificate is calculated by subtracting a predetermined amount from the estimated value of the electronic digital certificate.

12. The computer program product according to claim 8, wherein the non-transitory computer-readable medium comprises code causing the first apparatus to assign an insurance policy for the resource based on the predetermined values describing the specific attributes of the resource.

13. The computer program product according to claim 12, wherein the non-transitory computer-readable medium comprises code causing the first apparatus to:
receive, from a user, real-time values describing the specific attributes of the resource;
compare the real-time values describing the specific attributes of the resource to the predetermined values describing the specific attributes of the resource; and
if the real-time values describing the specific attributes of the resource are not equal to the predetermined values for the specific attributes of the resource, revoke the insurance policy for the resource.

14. The computer program product according to claim 12, wherein the non-transitory computer-readable medium comprises code causing the first apparatus to:
receive, from a user, real-time values describing the specific attributes of the resource;
compare the real-time values describing the specific attributes of the resource to the predetermined values describing the specific attributes of the resource; and
if the real-time values describing the specific attributes of the resource are not equal to the predetermined values for the specific attributes of the resource, alter the insurance policy for the resource.

15. A method for real-time assessment of electronic digital certificates, the method comprising:
generating an electronic digital certificate associated with a resource, wherein the resource has specific attributes;
recording the electronic digital certificate on a distributed ledger;
generating a metadata layer for the electronic digital certificate, wherein the metadata layer comprises predetermined values describing the specific attributes of the resource;
determining, based on the predetermined values describing the specific attributes of the resource, an estimated value of the electronic digital certificate; and
recording the estimated value in the metadata layer of the electronic digital certificate.

16. The method according to claim 15, further comprising:
receiving, from a user, real-time values describing the specific attributes of the resource;
comparing the real-time values describing the specific attributes of the resource to the predetermined values describing the specific attributes of the resource; and
if the real-time values describing the specific attributes of the resource are not equal to the predetermined values describing the specific attributes of the resource, calculating an updated estimated value of the electronic digital certificate.

17. The method according to claim 16, wherein the updated estimated value of the electronic digital certificate is calculated by subtracting a predetermined amount from the estimated value of the electronic digital certificate.

18. The method according to claim 15, further comprising assigning an insurance policy for the resource based on the predetermined values describing the specific attributes of the resource.

19. The method to claim 18, further comprising:
receiving, from a user, real-time values describing the specific attributes of the resource;
comparing the real-time values describing the specific attributes of the resource to the predetermined values describing the specific attributes of the resource; and
if the real-time values describing the specific attributes of the resource are not equal to the predetermined values for the specific attributes of the resource, revoking the insurance policy for the resource.

20. The method according to claim 18, further comprising:
receiving, from a user, real-time values describing the specific attributes of the resource;
comparing the real-time values describing the specific attributes of the resource to the predetermined values describing the specific attributes of the resource; and
if the real-time values describing the specific attributes of the resource are not equal to the predetermined values for the specific attributes of the resource, altering the insurance policy for the resource.
